(19) United States
(12) Patent Application Publication
(10) Pub. No.: US 2018/0061094 A1
(43) Pub. Date: Mar. 1, 2018

(54) Method for Modeling and Interacting with Sequential Information

(71) Applicant: Paul Martin Chaikin, Los Angeles, CA (US)

(72) Inventor: Paul Martin Chaikin, Los Angeles, CA (US)

(21) Appl. No.: 15/246,546

(22) Filed: Aug. 25, 2016

(51) Int. Cl. G06T 11/20; G06T 3/60; G06T 11/60; G06T 17/20; G06F 3/0484

(52) U.S. Cl. CPC G06T 11/206; G06T 3/60; G06T 11/60; G06T 3/20; G06F 3/04845; G06F 3/04847; G06T 17/20

(57) ABSTRACT

The present innovation discloses a novel method for modeling and dynamically interacting with sequential information on or by way of an electronic device. This method proceeds in three steps: formulating a path or surface that exhibits rotational periodicity and a degree of topological plasticity, mapping sequential information to that model, and providing a means for interacting with the newly-modeled data. In short, this innovation introduces a new technique and system for zooming in on any given sequence of data points within a periodic infrastructure without losing sight of the entire spectrum of information.

### FIELD OF THE INVENTION

This invention provides a new method for visualizing and interacting with sequential information. It will serve to benefit several fields of innovation, including applied mathematics, computer science, information theory, data visualization, and signal processing.

### CROSS-REFERENCE TO RELATED APPLICATION

This application is a non provisional application that claims the benefit of provisional application No. 62/209,521, the entirety of which is incorporated herein by reference for all purposes.

### BACKGROUND OF THE DISCLOSURE

Innumerable techniques exist for modeling sequential data, and there exist many examples of techniques that call upon premises similar to those upon which the present disclosure is predicated. For example, the technique of mapping sequential data to a path or surface exhibiting rotational periodicity, such as a spiral, helix, or loxodrome, is at least as old as the Antikythera Mechanism. That famous device, which is believed to be more than 2,000-years-old and considered by many to be an early example of an analog computer, is emblazoned with two spiraling calendars. More recent proponents of the same technique include the 17th-century German polymath Athanasius Kircher, who famously mapped lunar cycles to a spiral in Ars Magna Lucis et Umbrae, and Antonio Gabaglio, the 19th-century Italian statistician who mapped the history of the Italian post office to a calendrical spiral in Teoria Generale ella Statistica.

The aforementioned examples showcase some of the advantages of their shared technique, including the simultaneous representation of sequential and periodic aspects of calendrical time and a higher density of meaningful information than would be afforded by a linear or merely sequential modeling technique. However, as static visualizations, these examples provide no method for a user to modify the modeled data. This only becomes a possibility with the advent of electronic devices, and the associated capacity to create dynamic, interactive models of sequential information on or by way of electronic devices.

Any proposal to model sequential data to a path or surface exhibiting rotational periodicity—such as a timeline hewing to a spiral—is likely to discover an interesting and heretofore unresolved difficulty: zooming along a periodic manifold. In the case of a spiral, as displayed on or by way of an electronic device, any attempt to zoom in on a subsidiary portion of the entire path will come at a high cost and a loss of local context (i.e. as measured along the path of the spiral itself). Prominent methods for zooming or otherwise rescaling or shifting a subsidiary range within a broader context tend to be optimized for Cartesian coordinate systems, and not for the polar or log-polar coordinate systems that are more conducive to mapping periodic manifolds.

The technique of mapping sequential data to a path or surface exhibiting rotational periodicity has evolved considerably since the advent of electronic devices. Recent proposals have refined and reimagined this technique, directed it to various purposes, and articulated a wide range of potential instantiations (see, for example, U.S. Pat. No. 7,869,833 (2011), U.S. Pat. No. 9,146,111 (2013), U.S. Pat. No. 8,522,163 (2008), U.S. Pat. No. 7,418,674 (2004), U.S. Pat. No. 8,281,244 (2009) as well as U.S. Patent Application Publications 20100214285 (2010) and 20140310598 (2014)). Some of these proposals acknowledge the difficulty in delimiting the visible range of information in the context of a polar coordinate space, and offer techniques for dynamically delimiting the visible range of the proposed model. Nevertheless, these proposals and other attempts to model sequential data along paths or surfaces exhibiting rotational periodicity remain ill-equipped to zoom or otherwise rescale or shift a subsidiary range in a manner that invites smooth expansion and compression of the visible spectrum of information while maintaining completeness, sequential continuity, and unchanging rotational periodicity.

### SUMMARY OF THE DISCLOSURE

A method for modeling and dynamically interacting with sequential information by mapping it along a path or surface exhibiting rotational periodicity, such as a spiral, helix, or loxodrome, in which the contour of the given path or surface can be stretched so as to emphasize areas of interest while leaving other portions of the path or surface vague, compressed, or invisible. The given path or surface can also be subjected to basic geometric transformations (e.g. rotation, projection, inversion), divided into discrete, subsidiary paths or surfaces, and otherwise manipulated to further accentuate particular areas of interest. In a characteristic embodiment, a helix populated with sequential information can be variably stretched or compressed like a spring, pinched at one end to form a conchospiral, and projected onto a plane orthogonal to its axis of rotation as a spiral. This novel method for visualization and dynamic interaction is versatile, but especially well-suited to structuring a high-density stream of periodic or calendrical data points.

### BRIEF DESCRIPTION OF THE ILLUSTRATIONS

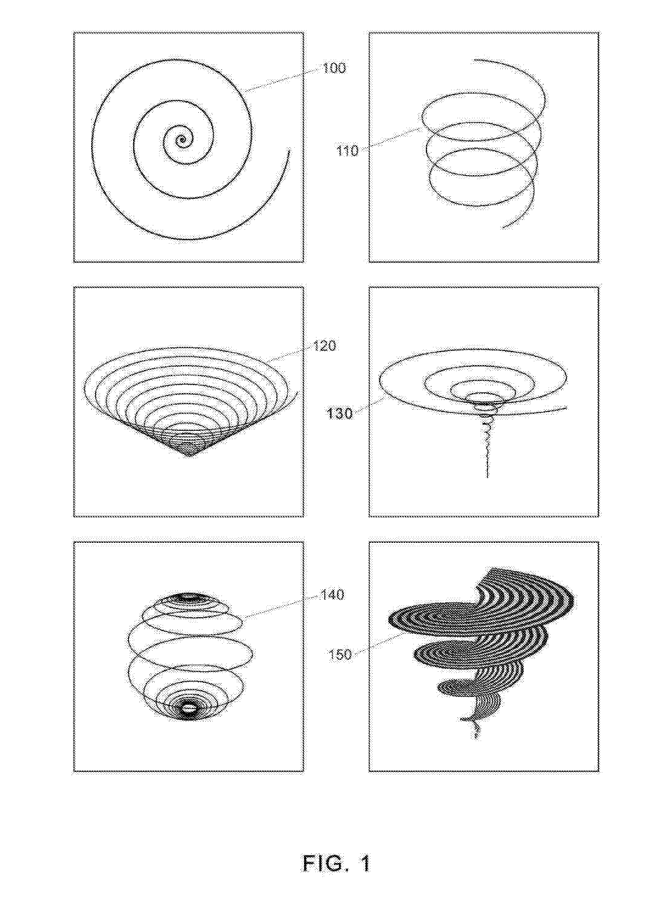

FIG. 1 is an illustration of various paths and surfaces exhibiting rotational periodicity, including a spiral, helix, conical helix, conchospiral, loxodrome, and conical helicoid.

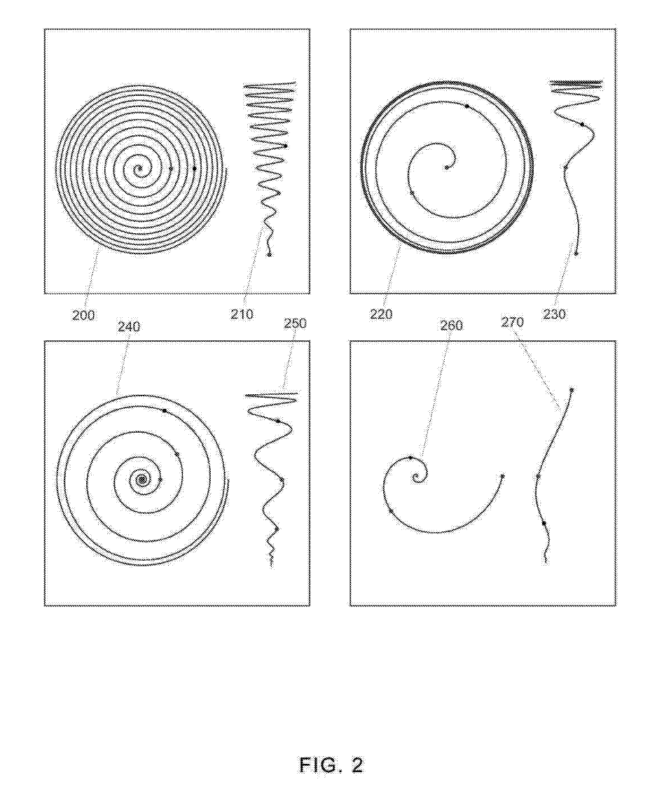

FIG. 2 is an illustration of a variously compressed spirals and vortices, each exhibiting precisely calibrated topological plasticity.

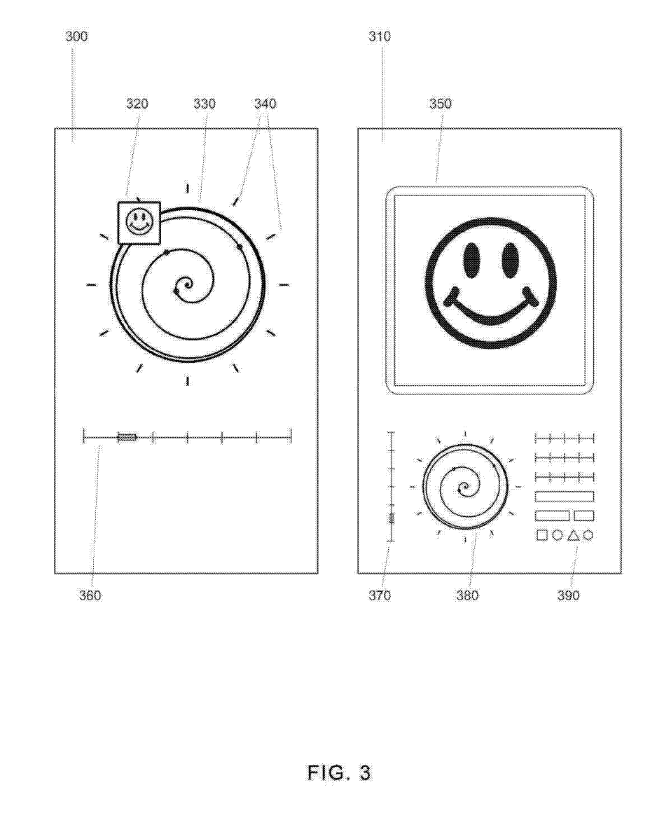

FIG. 3 is an illustration of two potential graphical user interface platforms.

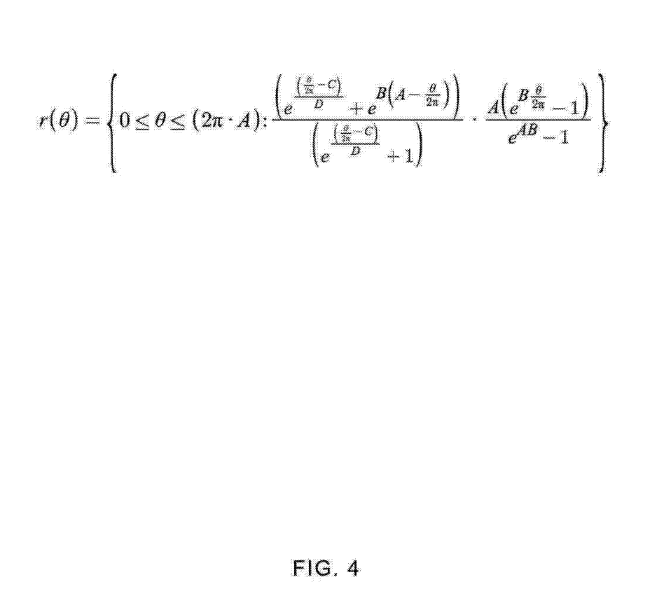

FIG. 4 is a mathematical formula referenced in claim 2.

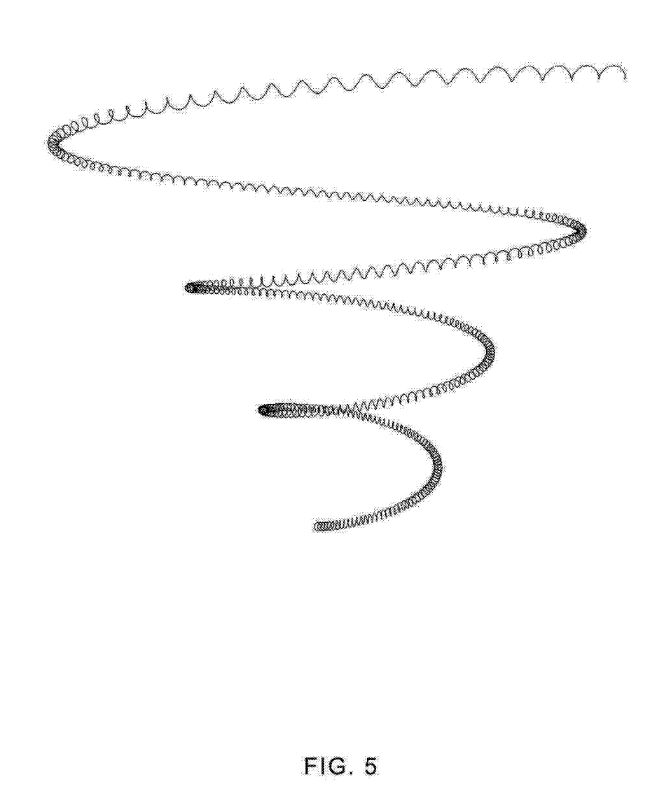

FIG. 5 is an illustration of a superhelix.

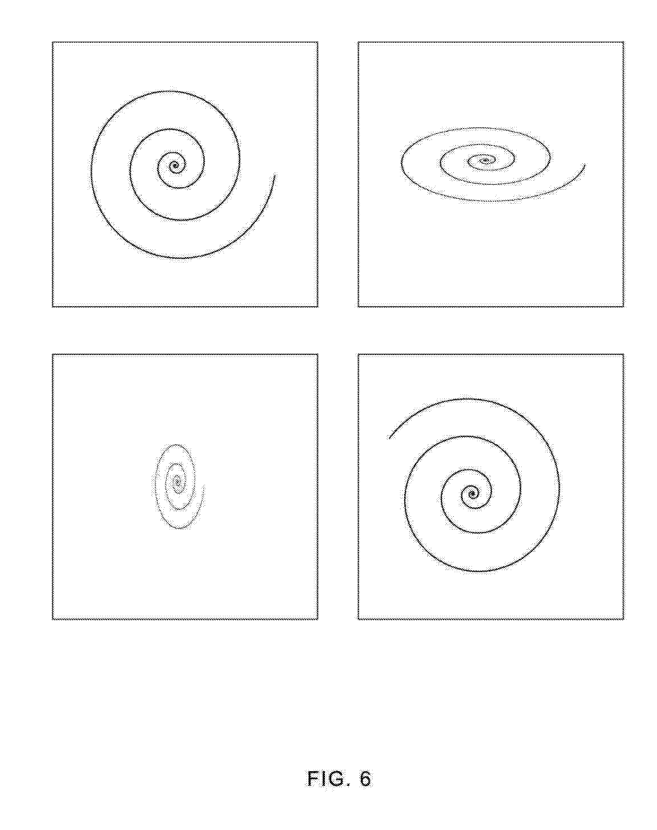

FIG. 6 is an illustration of a given spiral subjected to simple, geometric transformations.

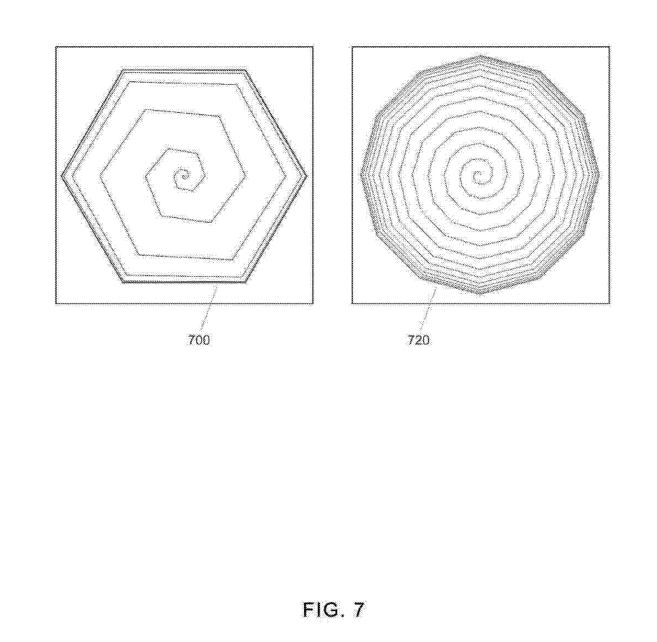

FIG. 7 is an illustration of two spirals with contrasting rotational resolutions.

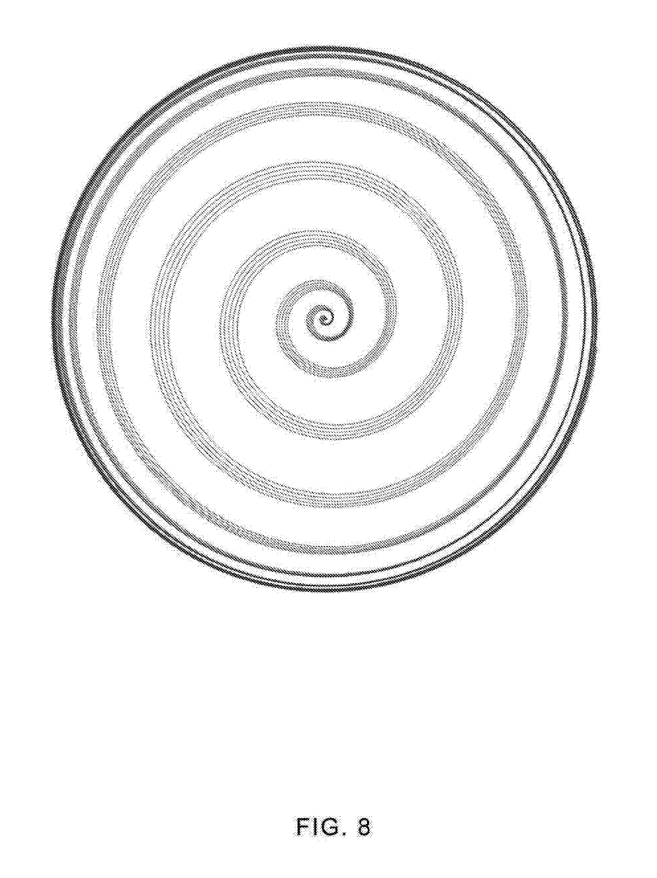

FIG. 8 is an illustration of multiple paths within a single coordinate space, obtained by replicating and rotating a given spiral.

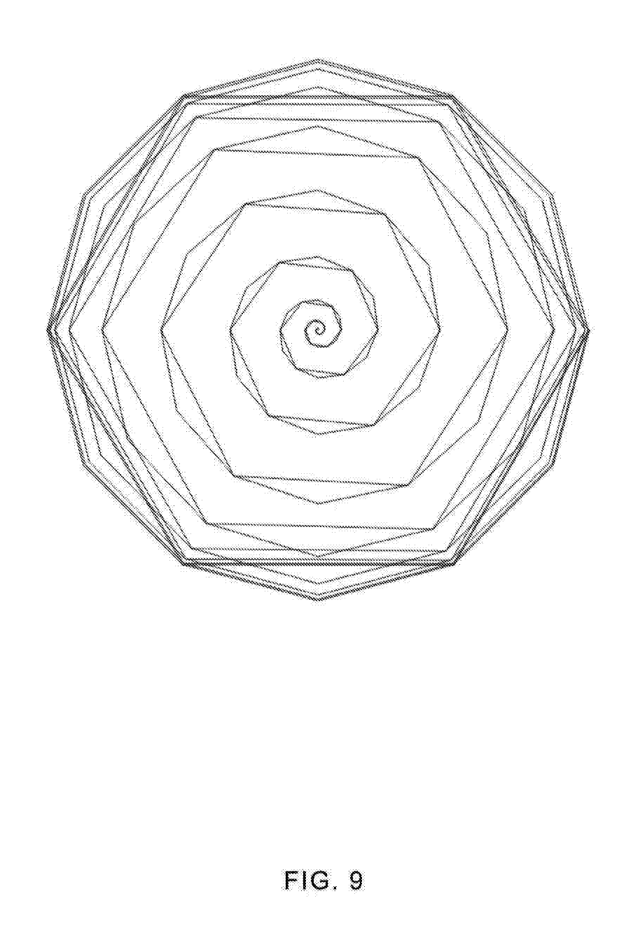

FIG. 9 is an illustration of multiple paths within a single coordinate space, obtained by rendering a given spiral in two contrasting rotational resolutions.

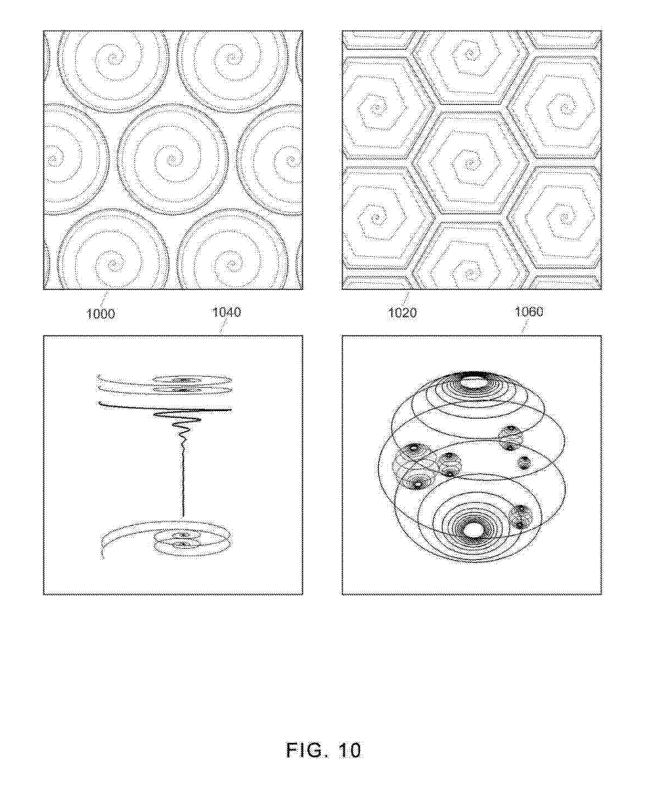

FIG. 10 is an illustration of multiple paths in multiple coordinate spaces.

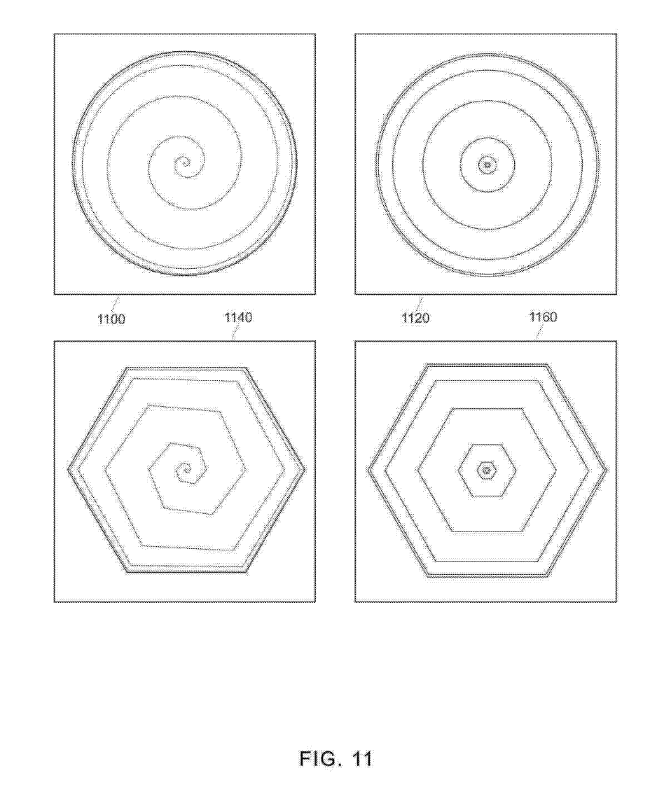

FIG. 11 is an illustration of formulated paths and associated piecewise renderings of those paths, yielding sequences of concentric figures.

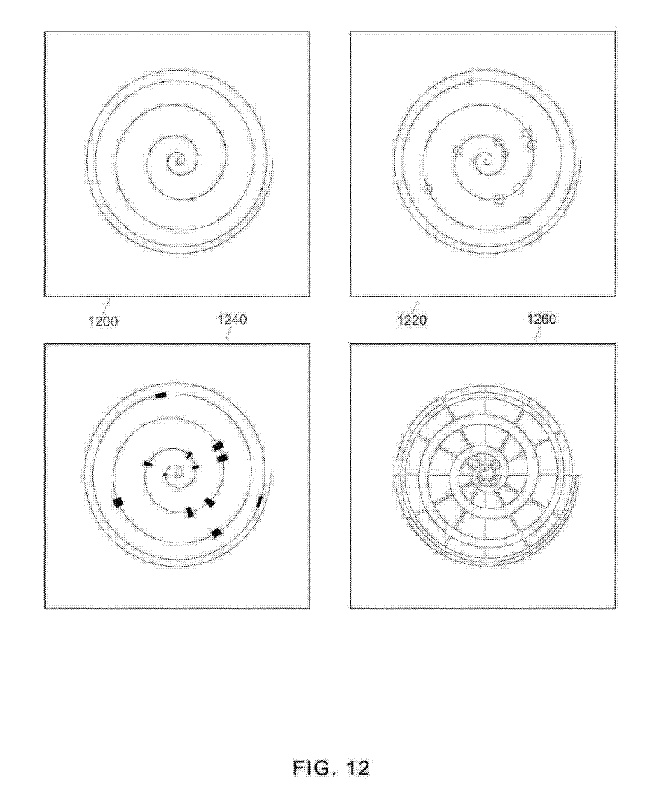

FIG. 12 exhibits potential shapes for representing single or aggregated data points along a given path or surface.

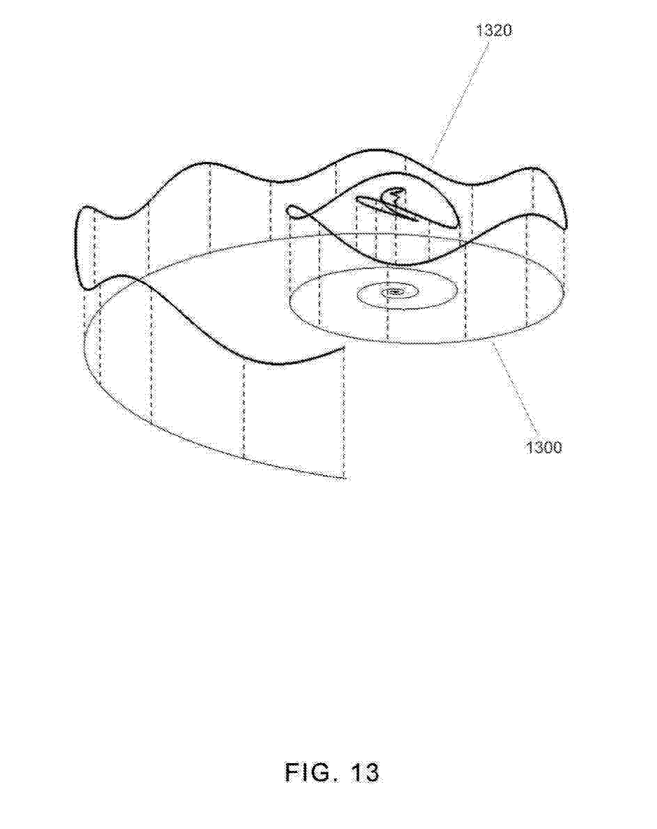

FIG. 13 is an illustration of a path in which the path itself forms an axis for mapping additional information within a topologically deformed coordinate space.

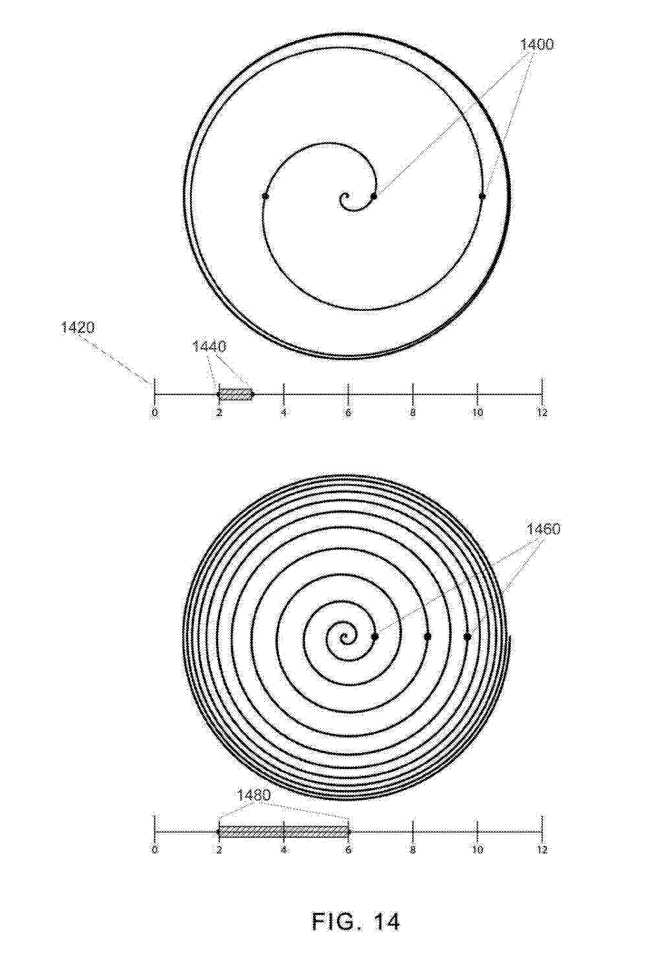

FIG. 14 is an illustration of a slider equipped to control the expansion and compression of a given path or surface.

### DETAILED DESCRIPTION

A novel method for interacting with sequential information on an electronic device is described here in detail. This description begins with an account of the method itself, before proceeding through a number of potential embodiments.

The method itself requires three steps, each described here in detail.

First, a path or surface is formulated such that it exhibits both rotational periodicity and a degree of topological plasticity.

Rotational periodicity here refers to the quality exhibited by spirals and helicoids, for example, in which a given path or surface repeatedly and visibly loops back to a particular frame of reference. In polar coordinates, this frame of reference is likely to be a polar angle and any coincident angles (e.g. 0, 2π, 4π, etc.). In addition to spirals and helicoids, a number of well-known paths and surfaces—including but not limited to helices, vortices, conchospirals, loxodromes, conical helicoids, log-polar grids, daisies, and superhelices—exhibit rotational periodicity. Six such shapes are displayed in FIG. 1, namely, a spiral 100, helix 110, conical spiral 120, conchospiral 130, loxodrome 140, and conical helicoid 150.

Topological plasticity here refers to the capacity for paths, surfaces, shapes, and other defined spaces to swell, compress, and otherwise deform without sacrificing some fundamental properties. A cube, for example, can be molded into a sphere while maintaining some essential integrity and coherence as an object. As a result, these two shapes, in the context of topological thought, are said to be homeomorphic. Similarly, a coffee mug with a handle can be molded into doughnut, and thus these two shapes are said to be homeomorphic. In the present context, however, the need for topological plasticity is partial and delimited: for a given path or surface, the capacity for topological plasticity is specifically calibrated to invite smooth expansion and compression of the visible spectrum of information while maintaining completeness, sequential continuity, and unchanging rotational periodicity.

Second, sequential information is mapped along any such path or surface. This mapping might entail, for example, plotting discrete data points or block-like shapes of aggregated data directly on or in close proximity to the path of a formulated helix. As stated above, any information mapped according to the given method will remain discoverable, sequentially situated, and, most significantly, fixed with respect to indices of rotational periodicity. A data point mapped along a spiral, for example, might move closer or further from the center of the spiral, but the polar angle of its polar coordinates will never change.

Third, a computational method is devised for navigating, modifying, expanding, compressing, analyzing, and otherwise interacting with a newly-modeled dataset or stream on an electronic device, or by way of an electronic device (e.g. as a projection, hologram, etc.). This method further entails formulating variable control points that act as bookends for any desired level of expansion or compression. By shifting the sequential position of these control points, the loops of a spiral, for example, can be smoothly and continuously expanded or compressed, thereby achieving a capacity for magnification and minimization analogous to zooming in a Cartesian grid. FIG. 2 illustrates four levels of compression delimited by visible control points, both for spirals 200, 220, 240, and 260 and vortices 210, 230, 250, and 270. Although methods described in this document might yield compelling static visualizations, the central innovation concerns dynamic interaction facilitated by an electronic device. As such, a method for easily accessing and controlling specific parameters of a given path or surface is given in the form of a graphical user interface, or GUI.

Some embodiments of the proposed graphical user interface consist simply in a visualization of a formulated path or surface 320, or a plurality of paths and surfaces, along with sequential information mapped to the given model. All requisite interactivity is made available through this singular component. Navigation or compression of the given information, for example, can take place through interaction with the model itself, by way of an input device, such as a keyboard, touchscreen, or trackpad.

In other embodiments, the central component 330 is supplemented by any of three subsidiary components (and any number of additional components). First, one or more linear sliders 360 provide users with a secondary method for shifting the aforementioned control points and otherwise interacting with the given model. Second, a control panel 390 provides users with access to other manipulable variables, including resolution and color scheme (discussed below), as well as a search box and virtual keyboard. Third, a content window 350 provides users with an additional framework for viewing data or metadata referenced in the given model (e.g. a datapoint along a spiral, for example, might correspond to an image in the content window).

Two potential embodiments of the proposed graphical user interface are illustrated in FIG. 3. In the first potential interface 300, the central component 330 is exhibited as a spiral. This data model is supplemented by a thumbnail window 320 for displaying content associated with particular data points, tick marks 340 for calibrating rotational periodicity, and a linear slider 360 for controlling the compression level of a given model. A second potential interface 310 includes a central component 380 and a linear slider 370, and is further supplemented by a content window 350 and a control panel 390 for accessing and manipulating additional features.

Collectively, the three steps described above comprise a novel method for interacting with sequential information on an electronic device. As a radial form of data visualization, this method is both efficient for mapping high-density data sets and well-equipped to disclose patterns in periodicity. This method—and, more specifically, the capacity to zoom in on any given sequence within a periodic infrastructure without losing sight of the whole spectrum of information—further enhances the well-established usefulness of radial data visualizations.

This central innovation can be refined and instrumentalized through a variety of embodiments. In the remainder of this thorough description, additional embodiments will be detailed, beginning with refinements to the central innovation and culminating with instantiations customized to contribute to specific markets and fields of research, including analysis, genomics, and data management.

In a preferred embodiment, sequential information is mapped to a spiral formulated to smoothly represent any number of loops as well as any subsection of that entire range. One way to accomplish this consists in three steps. First, devise a formula for representing a logarithmic spiral with a continuously manipulable pitch, with the path of the spiral extending from the origin of a polar coordinate system to a given endpoint, wherein the radial distance of that endpoint from the origin coincides with the exact number of loops exhibited by the spiral, as well as the polar angle of that final point divided by 2π. Second, perform a simple, inversive transformation on that logarithmic spiral, yielding a second spiral that is, in a sense, a complimentary inversion of the initial spiral. Third, elide the path of the first spiral into the path of the second at a given focal point using a smoothing function, such as a sigmoid curve. Together, these three steps yield a curve that exhibits the requisite topological plasticity to expand and compress the visible spectrum of information while maintaining completeness, sequential continuity, and unchanging rotational periodicity, as described above.

One formulation of this embodiment can be found in the the polar equation shown in FIG. 4, wherein A, B, C, and D are real independent variables, with A corresponding to the number of rotations exhibited by a given spiral as well as the radial distance between the endpoints of the given spiral, B indirectly corresponding to the pitch of the given spiral, C corresponding to the locus of transition between the two constituent spirals, and D corresponding to the pace of transition between the two constituent spirals.

Additional embodiments modify the preferred, spiral embodiment, discussed above, with two constituent paths or surfaces forming smooth, spline-like composites, calibrated for precise manipulation. In fact, a given formulation of the preferred, spiral embodiment, such as the formulation put forth in FIG. 4, can be parametrized to yield helices, vortices, conchospirals, loxodromes, conical helicoids, log-polar grids, and daisies, all endowed with precisely delimited topological plasticity.

Additional embodiments consist in helices nested within helices, a geometrical configuration known variously as a superhelix, supercoil, or superspiral. This shape—which, in essence, resembles a single thread coiled into a helical string, then coiled into a helical rope, and so on, indefinitely—provides a very efficient infrastructure for nesting information that is both sequential and multiply periodic, such as a time series. Superhelices can also be found in the natural order of things, from the molecular structure of proteins and genetic code to the paths of stars through the universe. A simple example of a superhelix—one helix coiling itself around the axis of another helix—can be seen in FIG. 5. In the context of the present innovation, a superhelical path is best understood as a navigable framework in which nested information of varying orders of magnitude is both discernible and discoverable.

Additional embodiments include simple, geometric transformations of any formulated path or surface. The spiral formulated in FIG. 4, for example, can be subjected to translation, reflection, rotation, projection, dilation, and inversion, both within 2-dimensional space and extending into 3-dimensional space, without losing its capacity to represent sequential information in a periodic and manipulable fashion. Some such transformations can be seen in FIG. 6.

Additional embodiments include the capacity to dynamically adjust the rotational resolution of a formulated path or surface. The rotational resolution here refers to the sampling rate, per rotation, undertaken by the electronic device rendering the path or surface. A formulated spiral, for example, might be set to a rotational resolution of six reference coordinates, or nodes, per rotation, yielding a path composed of six consecutive line segments per rotation. Such a path comes to resemble a hexagon, or more precisely, a whirl of nested hexagons. Such embodiments benefit from structuring an additional level of periodicity within an already periodic path or surface. In a spiral representing a time series with yearly loops, for example, a resolution of twelve nodes per rotation would come to resemble a whirl of nested dodecagons, wherein each segment is visibly aligned with a particular month (assuming months are regularized into twelve equal portions). Examples of paths with rotational resolutions of six 700 and twelve 720 can be seen in FIG. 7.

Additional embodiments render a given path or surface of sequential information as a single layer or multiples layers within a composite visualization of one or more related or unrelated layers of information. In other words, a spiral, for example, might be plotted, with a measure of opacity, over a geographical area of interest (e.g. in which the information mapped to the spiral relates directly to the geographical area it overlays). Similarly, a loxodrome might be plotted around a globe, the former enveloping the latter. In this instance, the loxodrome and the globe might rotate on separate axes, but come into alignment as directed.

A wide variety of embodiments include a method for rendering two or more paths or surfaces. Such embodiments can consist in a plurality of paths or surfaces, each associated with a single pair of endpoints and an associated pair of control points, or in a plurality of paths or surfaces associated with a variety of endpoints and associated control points. In some embodiments, a given path or surface is replicated and rotated, so as to render multiple paths or surfaces within a single coordinate space. A double helix, for example, can be rendered in this manner. Such pluralities, as exhibited in FIG. 8, form one exemplary embodiment for mapping parallel streams of data (e.g. two or more differentiated but simultaneous signals). Rotated multiples of a given path or surface can also act as envelope functions, setting spatial limits for information mapped along a central path or surface. In further embodiments, a given path or surface is multiply subjected to replication, rotation, and reflection, yielding a log-polar grid.

Some embodiments render two or more paths or surfaces with different rotational resolutions, as discussed above, to a single coordinate space. Such embodiments—an example featuring rotational resolutions of six and twelve, respectively, can be seen in FIG. 9—are especially well-suited to visualizing a plurality of periodicities within a given coordinate space.

Multiple paths and surfaces can also be rendered in multiple coordinate spaces. Such embodiments, illustrated in FIG. 10, invite the possibility of situating each path or surface in a broader context. A plurality of loxodromes 1060, for example, might be distributed in a 3-dimensional coordinate space according to a given geographical distribution, or according to a dynamic clustering algorithm. A plurality of spirals in parallel planes 1040 would allow users to stretch any one spiral into a conchospiral. Such pluralities might also be rendered as a lattice of tessellated or otherwise densely packed grid of paths or surfaces 1000. A plurality of spirals in which each exhibits a rotational periodicity of six, for example, could be tessellated as a lattice of hexagons 1020. Such a lattice could, in turn, comprise a layer within a composite visualization, as discussed above.

In further embodiments, as exhibited in FIG. 11, sequential information is rendered within piecewise increments, such that the given path or surface proceeds in step-wise fashion. In other words, a spiral 1100, for example, might be rendered as a sequence of concentric circles 1120, while a spiral with a low rotational resolution—say, six 1140—would be rendered as a sequence of concentric hexagons 1160. These bullseye-like embodiments enhance rotational symmetry at the expense of continuity.

Embodiments of the central innovation render sequential information along a given path or surface, or a plurality of paths and surfaces, by plotting data or metadata directly to the given path—such as a thumbnail of a photograph, plotted to a time series helix according to the date of its origination—or by coding data or metadata into visible, scalable indices of value. Such indices include but are not limited to color, opacity, shape, size, and orientation. A helical path, for example, might display sequential information in which color is correlated to one attribute of the given data set, size to another attribute, shape to another attribute, and so on.

The preferred shape for representing a data point or an array of data points depends, to some extent, on the shape and dimensionality of the given path or surface. On a single spiral in a 2-dimensional coordinate space, for example, data points could productively be represented as an assemblage of uniform or non-uniform shapes, including but not limited to circles, arcs, squares, regular polygons, bezigons, Delaunay triangles, Voronoi cells, quadtree cells, hyperbolic tilings, and Apollonian gaskets, in each case calibrated in their size to the available space. If the same spiral were to be represented as a disk or stretched into a conchospiral, in either case mapped in a 3-dimensional coordinate space, the variety of preferred shapes would grow to include space curves, spheres, cubes, regular polyhedra, and other 3-dimensional paths and surfaces. A variety of possible shapes for data points are exhibited in FIG. 12, including three illustrations of the same random distribution of points—as uniform circles 1200, variably sized-circles 1220, and variably-sized arcs 1240—as well as a single illustration of variably-sized arcs in a uniform distribution of twelve shapes per rotation 1260. The latter illustration would be especially useful as a framework for calendrical time (i.e. if each loop represents a year, each arc-like box constitutes a month).

Further embodiments entail a given path or surface acting doubly as a model for mapping sequential information and as an axis or frame of reference for mapping additional information along a secondary (and topologically deformed) coordinate space. A spiral, for example, might delineate one axis of a coiled plane orthogonal to the given spiral. In such an embodiment, a line chart might extend into this orthogonal plane, with its x-axis following the path of the given spiral, and its y-axis extending into the orthogonal plane.

In essence, such an embodiment resembles a 2-dimensional line chart rolled into a scroll, and yet the scrolled chart remains navigable. An examples of such an embodiment can be seen in FIG. 13, in which a spiral 1300 serves as a deformed x-axis, such that a line chart 1320 can be coiled into a scroll of unchanging periodicity. In a comparable embodiment, the x-axis follows the given spiral, while the y-axis remains coplanar but extends along rays emanating from the origin of the spiral, locally compressed so as to never overlap with prior or subsequent rotations. Such an embodiment is especially useful for mapping multidimensional data within a compact coordinate space.

Some embodiments privilege a graphical user interface optimized for direct manipulation of a given model of sequential information, by way of an input device, such as a touchscreen, mouse, or trackpad. In other words, a user's ability to navigate, scroll through, and otherwise interact with a given model proceeds directly from the user's engagement with that model, facilitated by an input device and a given catalogue of gestures (e.g. click, swipe, hover, etc.). Such embodiments are especially well-suited to electronic devices with relatively small screens, such as mobile devices.

Other embodiments foreground a graphical user interface with one or more linear sliders, further facilitating interaction with a given model. Such a slider 1420, as exhibited in FIG. 14, extends from a point correlated to a given model's point of origin to a point correlated to the same model's endpoint. The span between these two endpoints correlates to the entire range of the given model, rendered in a linear form, or, in some embodiments, rendered as a Cartesian coordinate space. In the latter case, the linearization of the entire range is supplemented by a y-axis that can serve to represent additional variables or periodicities (e.g. as a wave form). In either case, the slider is equipped with a pair of selectors 1440 correlating to bookends 1400 for expanding or compressing the visible range of the given model, as discussed above. The selectors can be repositioned 1480, and the bookends in the model are repositioned accordingly 1460. Some such embodiments include indexical tick marks along a given slider, as well as a plurality of subsidiary sliders for fine-tuning navigation at deeply nested levels of magnification.

Additional embodiments supplement a graphical user interface with a method by which certain initial characteristics of an instantiated model—including but not limited to plurality, shape, range, pitch, color scheme, and level of magnification—proceed from one or more automated algorithms. A spiral, for example, might be subjected to an adjustment of its emphasized range (i.e. an adjustment of the bookend selectors, discussed above) based on a weighted distribution exhibited by data points along the entire spectrum of sequential information. Similarly, a plurality of spiral paths might be mapped within a single coordinate space—as replicated and rotated paths, or as paths with varying rotational resolutions, or otherwise represented as a plurality—as a framework for disambiguating and displaying a complex, multiply periodic signal.

In some embodiments, the graphical user interface platform includes one or more windows in which any content (e.g. data, metadata, images) referenced in the given model can be visualized. In some embodiments, a single such window offers a user supplementary content associated with a single data point (e.g. a specific photo). In other embodiments, a single such window offers a user supplementary content associated with multiple data points or a data stream (e.g. the performance of a given stock over some given course of time, as highlighted in the given model). In still other embodiments, multiple such windows offer a user a multiplicity of supplementary content (e.g. the performance of several given stocks over a given course of time).

Thus far, this detailed description has delimited embodiments of the central innovation that serve to refine and enhance its functionality and versatility as a novel core technology. In the remainder of this detailed description, a few exemplary embodiments, customized to contribute to specific markets and fields of research, are introduced.

The central innovation has broad applicability, but it is especially well-suited to representing sequential information endowed with an implicit geometry of periodicity, such as a time series or a sequence of doubly-helical DNA.

With respect to time series, the central innovation provides a novel method for a user to navigate and otherwise interact with temporal data in a manner that preserves the integrity of both progression and periodicity. One such embodiment nests a plurality of paths or surfaces in a geometric and epistemological model analogous to a superhelix, as discussed above. Although the loops of spiral, for example, might recur at any conceivable intervallic rate, or at any assemblage of irregular intervals, this embodiment situates yearly loops as the default setting (in the context of a spiral or any other path or surface exhibiting rotational plasticity). As such, the given path or surface immediately serves as a navigable, multiyear calendar. As subsidiary time segments come into focus—by way of manipulating the plasticity of the given path, or by way of traditional, Cartesian zooming—new models, configured to represent subsidiary, nested levels of magnification and periodicity, become available to the user. A new spiral, for example, might come into view as a user stretches a multiyear spectrum into a single month. This new spiral is calibrated to an appropriate periodicity (in the given example, this periodicity is likely to be one day per rotation, extending in range to about one month). Further zooming yields further paths or surfaces, in each case calibrated to the order of magnification. This embodiment provides a basic framework for a great many variations, each exhibiting data associated with time.

Like time, genetic code is both sequential and periodic in nature. A characteristic embodiment of the central innovation models DNA so as to invite visualization, navigation, and analysis heretofore unavailable to genomics research. The complexity and multiply periodic geometry of DNA would be made more evident and navigable in embodiments optimized for examining molecular compounds. Such embodiments might nest genetic data in accordance with multiple orders of magnitude, wherein a user can seamlessly navigate between a view of an entire genome, a particular chromosome, a particular gene, a particular nucleosome, or even a particular base pair.

Another embodiment optimizes the given graphical user interface to serve as an advanced analytics platform, integrating a full suite of complementary tools, including but not limited to topological data analysis, predictive modeling, and real-time signal processing. The central innovation is itself topological in nature, and well-suited to parsing space and reducing dimensionality. Given the periodic fluctuations exhibited by a wide variety of phenomena, the present modeling technique, well-suited to exhibiting multiple periodicities, stands to contribute a great deal to established research methodologies. In a characteristic example, a conchospiral populated with data points might be extended in its visible range to include loops mapping out the near future. Patterns made evident in the given model might be variably accentuated as possible futures come into view. The capacity to combine predictive modeling with real-time signal processing further distinguishes the present innovation from most known techniques for rendering predictive analytics.

In another exemplary embodiment, the present innovation endeavors to resolve a longstanding insufficiency in image storage and navigation. In the most prevalent models for navigating sequential collections of images, a user scrolls through a linear sequence, frequently extending beyond the given screen space. The present innovation invites users to navigate a lengthy sequence of information, from beginning to end, in the spatial context of a single window. Furthermore, the periodicities with we which we all orient ourselves—e.g. seasonality, time of day, etc.—provide a user of this embodiment with an additional frame of reference for navigating a given time series or sequence. The capacity to forge a path or surface in which the field of emphasis can be easily expanded and compressed further enhances a user's capacity to move through a given sequence of information (e.g. a series of thumbnails) with great precision.

Another exemplary embodiment consists in a model that optimizes a user's capacity to navigate, aggregate, and disaggregate multiple datasets or streams of data. A single spiral, for example, might serve as a path for mapping multiple streams of social media data. This spiral might then be disaggregated into multiple spirals within a single coordinate space, as discussed above. A single spiral within this array might be foregrounded—by dilation, extension into 3-dimensions, etc.—while the other spirals remain vague in their legibility or dimensionality. In this embodiment, each path or surface might have an associated content window, as discussed above.

Further embodiments include but are not limited to every conceivable combination of the aforementioned embodiments.

What is claimed is:

1. A method for interacting with sequential information on or by way of an electronic device, the method comprising: formulating a path or surface that exhibits both rotational periodicity and topological plasticity specifically calibrated to invite smooth expansion and compression of the visible spectrum of information while maintaining completeness, sequential continuity, and unchanging rotational periodicity; and mapping a given dataset or stream along any such path or surface; and providing a computational method and graphical user interface for navigating, modifying, expanding, compressing, analyzing, and otherwise interacting with the newly-modeled dataset or stream on or by way of an electronic device.

2. The method of claim 1, in which a path is mapped along any portion of a spiral formulated as a smooth transition between two constituent curves: a logarithmic spiral with a given but manipulable pitch and a simple, inversive transformation of that logarithmic spiral, such as the formulated path given by the polar equation shown in FIG. 4, wherein A, B, C, and D represent real independent variables, with A corresponding to the number of rotations exhibited by the given spiral as well as the radial distance between the endpoints of the given spiral, B indirectly corresponding to the pitch of the given spiral, C corresponding to the locus of transition between the two constituent curves, and D corresponding to the pace of transition between the two constituent curves.

3. The method of claim 1, in which a path or surface is mapped along any portion of a helix, helicoid, vortex, conchospiral, loxodrome, conical helicoid, log-polar grid, daisy, or superhelix, in each case potentially formulated as a parameterization of a spiral endowed with sufficient topological plasticity.

4. The method of claim 1, further comprising a method for dynamically subjecting a formulated path or surface to simple geometric transformations, including but not limited to translation, reflection, rotation, projection, dilation, and inversion.

5. The method of claim 1, further comprising a method for dynamically adjusting the rotational resolution, or the sampling rate of coordinate vertices or edges per rotation of any rendered path or surface, yielding paths and surfaces composed of consecutive line segments or planes.

6. The method of claim 1, in which a given path or surface consists in a single layer or multiples layers of information within a composite visualization of one or more related or unrelated layers of information, such as a spiral plotted over a geographical area of interest, or a loxodrome plotted around (and enveloping) a globe.

7. The method of claim 1, further comprising a method for rendering two or more paths or surfaces, including but not limited to instantiations in which a given path or surface formulation is replicated and subsequently rotated, reflected, otherwise subjected to a simple geometric transformation, or subjected to a change in rotational resolution, so as to render multiple paths or surfaces within a single coordinate space, or in which two or more paths or surfaces appear in two or more coordinate spaces, such as a lattice of tessellated or otherwise densely packed plurality of given paths or surfaces.

8. The method of claim 1, further comprising a method for rendering sequential information within piecewise increments, such that the given path or surface proceeds in step-wise fashion, such that a spiral, for example, would be rendered as a sequence of concentric circles.

9. The method of claim 1, in which data or metadata associated with a given coordinate or set of coordinates along a given path or surface are represented directly or by variable scaling of visible characteristics, including but not limited to color, opacity, shape, size, and orientation.

10. The method of claim 1, further comprising a method for mapping data along a given path or surface with an assemblage of uniform or non-uniform shapes, including but not limited to circles, spheres, squares, cubes, regular polygons, regular polyhedra, bezigons, Delaunay triangles, Voronoi cells, quadtree cells, hyperbolic tilings, and Apollonian gaskets, in each case calibrated in their size to the available space.

11. The method of claim 1, in which a given path or surface serves as an axis for mapping additional information within a topologically deformed coordinate space, such as a line chart in which one axis hews to a given spiral while a secondary axis extends into a plane orthogonal to the given spiral.

12. The method of claim 1, further comprising a method for precisely adjusting the shape of a given path or surface by interacting with the model itself through the use of an input device, such as a keyboard, trackpad, or touchscreen.

13. The method of claim 1, further comprising a method for precisely adjusting the shape of a given path or surface through the use of one or more linear sliders.

14. The method of claim 1, further comprising a method for instantiating a model of the given sequential information in which certain initial characteristics—including but not limited to plurality, shape, range, pitch, color scheme, and level of magnification—proceed from one or more automated algorithms, such as an algorithm that expands the visible range to span two standard deviations from the mean of some shared metric, or an algorithm that establishes nested levels of periodicity through Fourier analysis of a given data set.

15. The method of claim 1, in which the graphical user interface platform includes a window for displaying data, metadata, images, or other content associated with a given dataset or stream and as specified along a given path or surface.

16. The method of claim 1, in which the given graphical user interface platform is customized for navigating, analyzing, and interacting with sequential information associated with an implicit geometry of periodicity, such as a time series or a sequence of doubly-helical DNA.

17. The method of claim 1, in which the given graphical user interface is customized to be an advanced analytics platform, integrating a full suite of complementary tools, including but not limited to topological data analysis, predictive modeling, and real-time signal processing.

18. The method of claim 1, in which the given graphical user interface platform is customized for displaying, navigating, and interacting with a sequence of images, such as a photo collection.

19. The method of claim 1, in which the given graphical user interface platform is customized for aggregating and disaggregating multiple data streams.

20. The method of claim 1, further comprising any combination of every subsidiary claim.
